(19) United States
(12) Patent Application Publication
(10) Pub. No.: US 2011/0043431 A1
(43) Pub. Date: Feb. 24, 2011

(54) ANTENNA ARRANGEMENT HAVING AT LEAST TWO DECOUPLED ANTENNA COILS; RF COMPONENT FOR NON-CONTACT TRANSMISSION OF ENERGY AND DATA; ELECTRONIC DEVICE HAVING RF COMPONENT

(75) Inventors: Christian Reinhold, Paderborn (DE); Peter Scholz, Muhltal (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/934,793

(22) PCT Filed: Sep. 3, 2009
(86) PCT No.: PCT/EP2009/001675

§ 371 Date: Sep. 27, 2010

(30) Foreign Application Priority Data
Apr. 4, 2008 (DE) 102008017622.2

(51) Int. Cl. H01Q 7/00

(52) U.S. Cl. 343/867

(57) ABSTRACT

There is provided an antenna arrangement for RF systems. An exemplary antenna arrangement comprises at least two antenna coils that are installed on a flat, non-conductive carrier. The first antenna coil as well as the second antenna coil comprise one or more windings that are applied onto the carrier. The antenna coils are arranged in at least two different layers that are one above the other and that do not touch each other. The first antenna coil is of a first quality and the second antenna coil is of a second quality. The first antenna coil is arranged so as to be offset with respect to the second antenna coil in such a way that the mutual inductance between the two antenna coils is minimized.

### CROSS-REFERENCE TO RELATED APPLICATIONS

Pursuant to 35 U.S.C. §371, this application is the United States National Stage Application of International Patent Application No. PCT/EP2009/001675, filed on Mar. 9, 2009, the contents of which are incorporated by reference as if set forth in their entirety herein, which claims priority to German (DE) Patent Application No. 10 2008 017 622.2, filed Apr. 4, 2008, the contents of which are incorporated by reference as if set forth in their entirety herein.

### BACKGROUND

It is a known procedure to use antennas in the realm of contact-free energy and data transmission. Particularly in contact-free data transmission, RFID (Radio Frequency Identification) systems are used. Such a system normally consists of an RFID chip (transponder/tag) that is attached, for example, to an object, to a person or animal, or to a fixed position, and it also consists of one or more reading and/or writing devices. The RFID chip can be read and written by the reading and/or writing device contact-free via high-frequency signals if the RFID chip is located within the range of one of these devices.

From a technological point of view, RFID systems and the associated transponders can differ a great deal from each other. An important differentiation feature is the type of energy supply for a transponder. Here, a distinction is made between active and passive RFID transponders, whereby active transponders have their own energy supply, for example, in the form of a battery, while passive transponders obtain the energy needed for their operation from the radio signal of a base station. Normally, passive RFID tags are used whenever the aim is to attain the smallest possible sizes at low production costs. In contrast, active transponders with their own energy supply are larger and their production entails higher costs.

A passive transponder has an antenna, for example, in the form of an antenna coil with at least one winding, via which the energy can be drawn from the signal of a reading and/or writing device. Battery-free transponders normally receive their supply voltage through induction from the radio signals of the appertaining base station. Using a coil as the antenna, a capacitor is charged through induction and this capacitor supplies the transponder with energy. The coil can be wound or printed, and it is in communication with a chip. As soon as the antenna coil moves into the high-frequency electromagnetic field of a base station, an induction current is generated in the antenna coil and rectified so that it can be used by the chip.

Data is also transmitted contact-free via antennas between the trans-ponder and a base station. The transmission of information between the trans-ponder and a reading device is based on the modulation of the electromagnetic field that is generated by a coil of the reading device. If the transponder is in the electromagnetic field of the reading device, it can generate the energy needed for its operation from this electromagnetic field, and it can then cause a fluctuation in the field of the carrier wave that can be detected and evaluated by the reading device.

The small size of passive transponders is associated with a smaller range than that of active transponders. The range of passive transponders, depending on the selected frequency and on the resultant coupling, is between a few centimeters and up to 10 meters, whereas active transponders can have a range of up to 100 meters. Consequently, the use of active or passive transponders depends, among other things, on the area of application and on the requisite ranges.

However, RF components can be used not only for the identification of objects, persons or animals, or positions by means of RFID tags, but they can also be used for any kind of contact-free transmission of energy and/or data by means of high-frequency signals. This is the case, for example, with electronic labels based on electronic ink. International patent application WO 02/063602 A1 discloses electronic labels in which RF components are used to transmit information to a label containing electronic ink. Such a label can likewise be configured to be passive, without its own energy supply, whereby the requisite energy is transmitted via high-frequency signals to an antenna of the label. Here, it can be provided that one antenna is provided for the energy transmission and one antenna for the data transmission. Such an electronic label does not necessarily have to also transmit data to a reading device, but rather, if so desired, information is only transmitted from a write device to the label so that this information is displayed by the bi-stable elements of the electronic ink.

In the case of passive RFID systems with a high energy requirement, there is a need to solve the problem that there is a need for a sufficient energy supply with antenna structures of higher quality with which a high power can be transmitted at freely selectable voltages. In fact, however, such antenna structures cannot be combined with antenna structures of an RFID chip or of similar communication units. Normally, a surge suppressor of the transponder chip prevents higher voltages. The voltage can be limited, for example, to 8-10 volts, meaning that higher voltages cannot be reached on the antenna. Although the voltage could be subsequently increased by installing appropriate circuits, this is not desirable for reasons having to do with cost and functionality. On the other hand, a transponder oscillating circuit only calls for a lower quality than an energy circuit since, in the latter case, data has to be transmitted on the modulation side-bands. However, with a narrow-band antenna, which is desirable for efficient energy transmission, this is hardly or not at all possible.

For other problems encountered in the realm of data and/or energy transmission in RF systems, it can also be advantageous to provide several antennas on one RF component; however, these must not interfere with each other.

Before this backdrop, the objective of the invention is to provide an antenna arrangement for RF systems that allows the use of at least two antennas which, however, do not interfere with each other. In particular, an RF component is to be put forward that can be used in a simple manner to transmit energy as well as data to an electronic device that has a high energy requirement. In particular, the RF component should be suitable for the transmission of energy and data to flat electronic labels based on electronic ink.

### SUMMARY OF THE INVENTION

Exemplary embodiments of the invention relate to an antenna arrangement and to an RF component having such an antenna arrangement. Moreover, an exemplary embodiment relates to an electronic device having an RF component for contact-free transmission of energy and data to the electronic device.

An antenna arrangement for RF systems according to an exemplary embodiment comprises at least two antenna coils that are arranged in at least two different layers that are one above the other and that do not touch each other. A first antenna coil is arranged so as to be offset with respect to a second antenna coil, and the mutual inductance between the two antenna coils is minimized. Here, the windings of the first antenna coil and the windings of the second antenna coil overlap, preferably in a partial area of each antenna coil.

The distance between the two layers of antenna coils may be in the order of magnitude of 0.1 mm to 2 mm, especially about 1 mm. Moreover, both antenna coils can be operated at the same frequency which, in an exemplary embodiment of the invention, is 13.56 MHz.

The two antenna coils may be installed on a flat, non-conductive carrier. The first antenna coil as well as the second antenna coil can include one or more windings that are applied onto the carrier, whereby the two antenna coils thus formed are arranged so as to be offset with respect to each other along an axis A that runs through the midpoint of each of the two antenna coils.

For example, the two antenna coils may be configured to be rectangular with rounded-off corners, whereby they each have an outer length L=50 mm and an outer width B=50 mm, and the midpoints of each of the antenna coils may be arranged so as to be offset with respect to each other by Δ=39 mm along an axis A that runs parallel to four opposite sides of the two antenna coils, whereby the first antenna coil has a conductor width of approximately 1 mm, and the second antenna coil has a conductor width of approximately 0.75 mm.

Exemplary embodiments of the invention also relate to an RF component having such an antenna arrangement. One of the antenna coils may be a narrow-band energy coil that is arranged on the surface of the carrier so as to be offset with respect to a broadband data coil, whereby the mutual inductance between the two antenna coils is minimized, and both antenna coils may be connected to an electronic assembly such as, for example, a microchip.

Furthermore, an exemplary embodiment of the invention comprises an electronic device having such an RF component for contact-free transmission of energy and data to the electronic device. The electronic device may comprise an electronic display based on electronic ink containing bi-stable elements, whereby the electronic display has an RF component according to the invention for contact-free transmission of energy and data to the electronic display.

In the realm of radio frequency technology, an exemplary embodiment of the invention entails the essential advantage that two antennas can be used in one component without interfering with each other. The two antennas can be arranged in a small space and can even be operated at the same frequency. They can be, for example, two energy coils, two data coils or one data coil combined with one energy coil. Moreover, two transponders whose antennas do not interfere with each other can be implemented in one component. Consequently, different protocols such as, for example, ISO 14443 and ISO 15693 can be used for reading out transponders with differently configured antennas on one label. An additional security aspect may be achieved when several transponders with different frequencies are used.

Particularly when an exemplary embodiment of the invention is used on electronic devices, it may allow energy and data to be transferred wireles sly to electronic devices of the type that could not previously be operated with RF technology because of their high energy requirement. According to an exemplary embodiment, planar integration of several antenna structures in close proximity allows the use of several antennas having different requirements without having to substantially enlarge the size of an electronic device. Thus, different voltage planes can be provided, and the energy and data transmission can be separated from each other, whereby the requirements of both modalities of transmission may be met.

The transponder chip remains virtually unaffected by the energy transmission, and the associated antenna design can be standardized using an antenna of low quality. The energy coil, in turn, is of higher quality so that it can achieve the conceivably higher voltage planes. Through a systematic shift of the two coils with respect to each other, it is easy to achieve that the mutual inductance and thus also the coupling of the two coils are minimized or even equal to zero.

This has the advantage that both antennas can be dimensioned and optimized completely separately from each other. Such an optimization can comprise, for example, the selection of different bandwidths, a different number of windings, and different conductor widths.

An exemplary embodiment may provide the advantage that both antennas can be operated at the same frequency, as a result of which there is no need to provide a multi-antenna system on an associated reading and/or writing device.

### BRIEF DESCRIPTION OF THE DRAWINGS

Exemplary embodiments of the present invention are described herein with reference to the accompanying drawings, without this restricting the general inventive idea in any way whatsoever.

The figures show the following:

FIG. 1 is a block diagram of an RF component according to an exemplary embodiment of the invention;

FIG. 2 is a block diagram of an electronic display with an RF component according to an exemplary embodiment of the invention; and

FIG. 3 is a graph showing a representation of a coupling factor between two antenna coils as a function of the relative shift of the two antenna coils with respect to each other, according to an exemplary embodiment of the invention.

### DETAILED DESCRIPTION OF SPECIFIC EMBODIMENTS

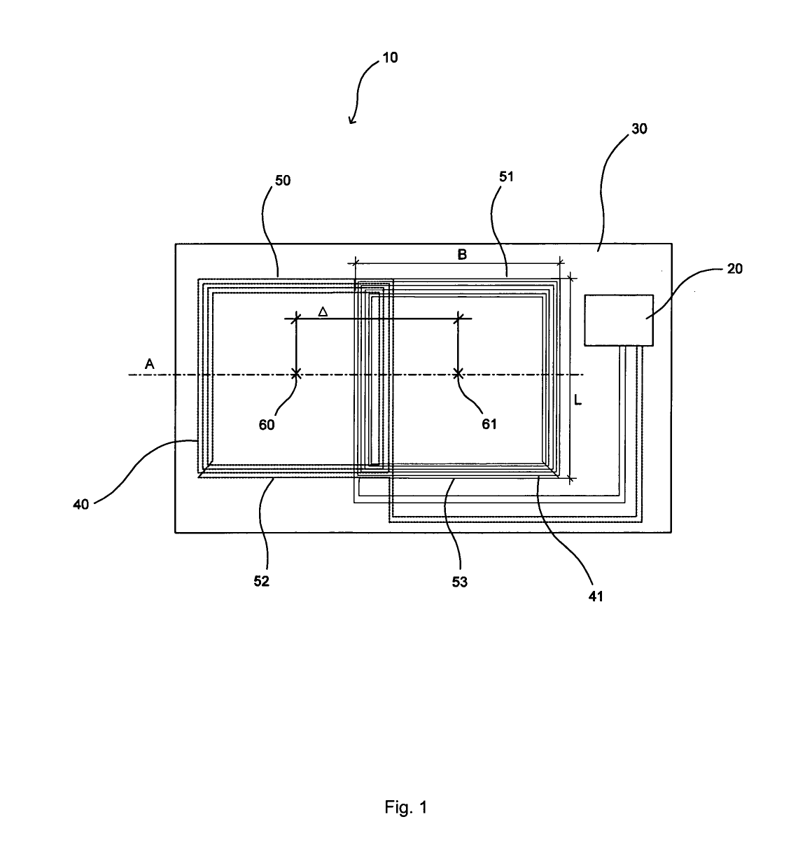

FIG. 1 shows an RF component according to an exemplary embodiment of the invention, whereby an RF component (RF=radio frequency) according to an exemplary embodiment is a component that receives and processes high-frequency radio signals. The term processing of radio signals means, among other things, the acquisition of energy from radio signals of a base station through induction and/or the modulation of an electromagnetic field of a base station.

The RF component 10 comprises at least of a non-conductive carrier 30 on which two antenna coils 40 and 41 and an electronic assembly such as, for example, a microchip 20 with an integrated circuit, are arranged. The carrier is preferably flat and plate-shaped. However, it can also comprise a film. The two antenna coils are connected to the microchip which, in turn, can be connected to an electronic device that is to be supplied with energy and data via the antennas. As an alternative, however, any other models and connections are possible. For example, each antenna coil can be connected to a microchip, or else a first antenna coil is connected to a microchip, while a second antenna is connected to discrete structural components.

Electronic devices that can be operated with the RF component according to the invention include, for example, electronic displays or sensors. However, the invention can also be used for any applications in which electronic information and energy have to be transmitted. Examples of these are data recorders, medical implants such as cochlea implants, retina implants, cardiac pacemakers and neuronal stimulators. Moreover, wirelessly operated actuators such as, for example, passively operated locking units or pumps are possibilities. However, then if the microchip comprises, for example, a memory in which data can be stored and retrieved by a reading device, the RF component can also be used as an autonomous component in the form of an RFID tag on objects, persons or animals, or positions.

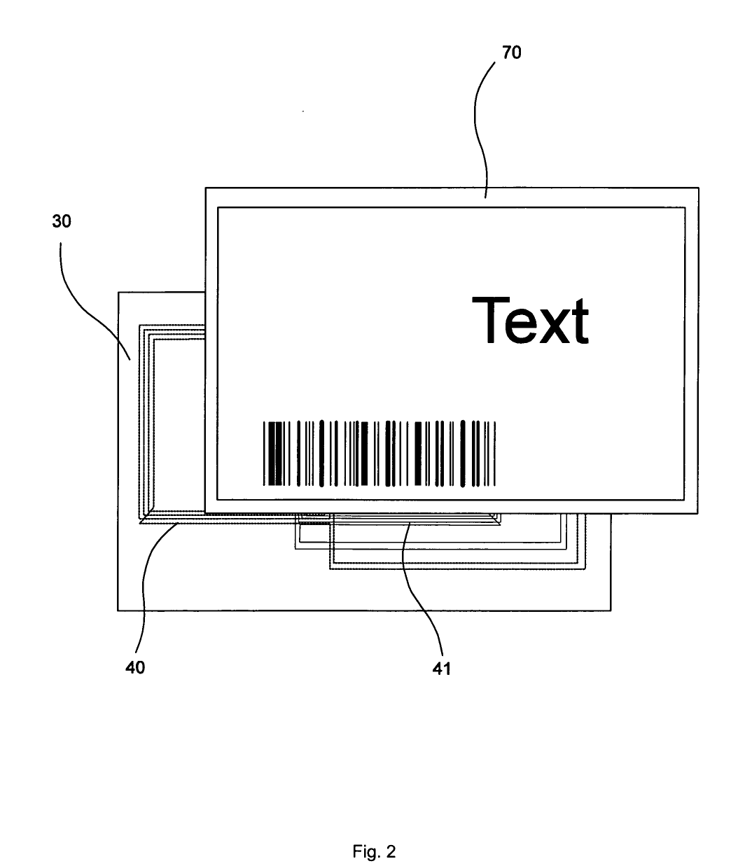

However, an exemplary embodiment of the invention may be suitable for operating a display 70 that is based on electronic ink and that is of the type shown in FIG. 2 with a display above a carrier 30 with two antennas 40 and 41. The RF component is connected to the display 70 and it receives variable data that comes from a base station and that is to be shown on a display. As an alternative, variable data is stored in a memory of the microchip 20 or in another memory of the electronic display 70 that is activated by signals of a base station and that is displayed using the bi-stable elements of the electronic ink. Energy is needed in order to influence the orientation of the bi-stable elements of the electronic ink, and this energy is likewise received via the RF component 10.

The non-conductive carrier 30 preferably comprises a plastic. For example, it is possible to use fiberglass mats impregnated with epoxy resin, which are also known for use in printed circuit boards. At least two conductive antenna coils 40 and 41 are printed onto the carrier 30 or created there using etching methods. In order to better differentiate between the two coils, the windings of a first antenna coil 40 are depicted with a broken line in FIG. 1, while the windings of a second antenna coil 41 are depicted with a solid line. In the exemplary embodiment shown in FIG. 1, these are four rectangular coils, each with at least one winding and rounded-off corners. However, any curved or polygonal shapes with at least one winding may also be used.

Preferably, an antenna coil has several windings and their ends are connected, for example, to the microchip 20, to additional microchips or to other discrete components. Furthermore, it is possible to provide more than two antennas on one carrier 30. The coils have to be arranged in an-antenna arrangement according to an exemplary embodiment of the invention so as to be shifted with respect to each other in such a way that their coupling is very slight or equal to zero. In the case of several coils, the arrangements needed for this purpose can be ascertained by analytical expressions, by simulation tools or by empirical determination.

According to an exemplary embodiment of the invention, the first antenna coil 40 is a high-quality, narrow-band energy coil. This coil serves to supply the microchip 20 and a connected device with energy in that a current flow is generated through induction as soon as the energy coil 40 enters the high-frequency electromagnetic field of a base station. A second antenna coil 41 is a lower-quality, broadband data coil. This antenna coil 41 serves to transmit data to the microchip or to a connected electronic device.

In an antenna arrangement according to an exemplary embodiment of the invention, the two antennas are arranged in two different layers on the carrier 30 and they do not touch each other. Moreover, the antenna coils 40 and 41 are arranged so as to be offset with respect to each other on the surface of the carrier 30. The two antennas are positioned in such a way that the mutual inductance and thus the coupling of the two antenna coils are minimized or even equal to zero. If a current is flowing in one antenna, this has little or no effect on the other antenna. A current flow, for example, in the energy coil 40, causes a magnetic flux which, however, does not induce any voltage in the data coil and is completely decoupled, and vice versa. The field lines run—in parts—in the direction of the normal vector and—in other parts—opposite thereto, so that the total flow adds up to zero. Consequently, the two antennas are decoupled from each other and can be operated completely separately from each other.

The rectangular antenna coils 40 and 41 are preferably arranged in such a way that the windings of the energy coil 40 and the windings of the data coil 41 overlap in a partial area of each individual antenna coil. In the exemplary embodiment shown in FIG. 1, the windings of the two coils overlap, for example, in the area of one lengthwise side of a coil. In order to achieve this overlapping, the two antennas are advantageously applied in two different layers. The distance between these layers is preferably in the order of magnitude of 1

If the energy coil 40 and the data coil 41—as is the case in the embodiment in FIG. 1—include one or more rectangular windings that are printed onto the carrier 30, then the two rectangular antenna coils thus formed have the same orientation. The opposing sides 50 and 52 of a first antenna coil 40 thus run parallel to the corresponding sides 51 and 53 of the second antenna coil 41. In this case, the antenna coils are arranged so as to be offset with respect to each other along an axis A that runs parallel to these four opposite sides 50, 51, 52 and 53 of the two antenna coils 40 and 41. Here, the midpoints 60 and 61 of the two antenna coils undergo a relative shift A.

In the exemplary embodiment shown in FIG. 1, both antennas 40 and 41 are equal in size and have an outer length L=50 mm and an outer width B=50 mm. The first coil 40 has four windings, whereas the second coil 41 has six windings. The conductor width of the first coil 40 is about 1 mm, while the conductor width of the second coil is about 0.75 mm. In an exemplary embodiment, the distance between the conductors is about 0.3 mm in both antenna coils 40 and 41. The distance between the two layers of the antenna coils is in the order of magnitude of 0.1 mm to 2 mm, and preferably at about 1 mm. However, any distances that are possible with the desired component can be realized.

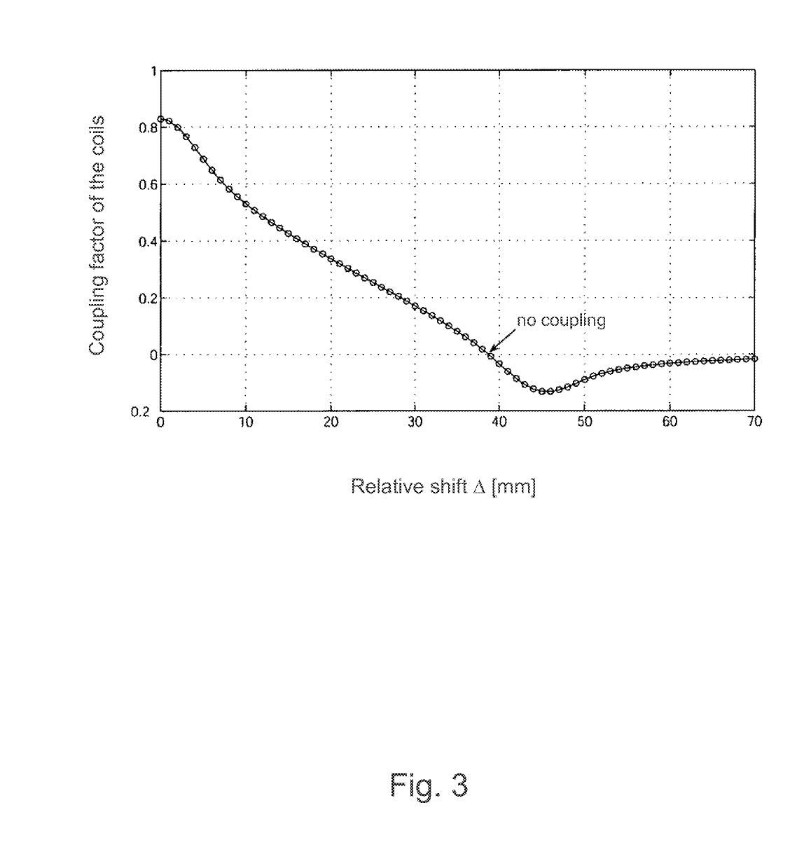

In this case, it has been found that the two antennas have to be shifted relative to each other in such a way that their midpoints 60 and 61 have to be arranged so as to be offset with respect to each other by about Δ=39 mm along an axis A in order to achieve a decoupling of the two antenna coils. In the case of other coil shapes and sizes, the requisite shifts are different and they will have to be determined on a case-to-case basis. This can be done using tests and/or computer simulations. A simulated coupling of the two described coils can be seen in the graph of FIG. 3. Here, the requisite relative shift A in millimeters is plotted on the abscissa, whereas the coupling factor of the coils is plotted on the ordinate.

The coupling factor is defined as the ratio between the mutual inductance and the square root of the product of the self-inductances. The coupling factor is also designated as k: k=M/\sqrt{L₁L₂}, wherein M is the mutual inductance of the two coils with respect to each other and L₁ and L₂ are the self-inductances of the coils.

As can be seen in FIG. 3, a coupling factor of zero is obtained at a relative shift of the two antenna coils with respect to each other of approximately Δ=39 mm, so that the two antennas are decoupled in such an arrangement and can be operated independently of each other.

In an exemplary embodiment of the invention, the energy coil 40 and the data coil 41 can be operated at the same frequency. This frequency is, for example, 13.56 MHz. This has the advantage that an appertaining base station does not need a multi-antenna system in order to provide energy and data, but rather can be operated at one frequency.

FIG. 2 shows an electronic display 70 above an RF component 10 according to the invention. The display 70, like the RF component 10, is preferably configured to be very flat so that the display 70—when applied onto the RF component—forms a flat electronic device that can be used, for example, as a label in various areas of application where variable information is to be shown on a display. The electronic display medium employed is preferably electronic ink, based on bi-stable elements. Chemically speaking, these may include microcapsules containing two different color components that have different charges and that are oriented in the electric field. Due to the particle sizes and the viscosity of the system, relaxation back to the unordered initial state does not occur immediately after the electric field has been switched off. Hence, the written information is not lost but, at most, there is merely a decrease in the contrast.

Examples of electronic ink are the products SmartPaper™ made by the Gyricon company and electrophoretic displays made by the E Ink company. Electrophoretic displays have favorable properties, especially in terms of the mechanical requirements regarding flexibility, impact-resistance and pressure-stability, so that they are especially well-suited for use as labels. Furthermore, they have sufficient bi-stable behavior and the circuitry required for the energy supply is limited, thanks to the relatively low control voltage.

The energy received from a base station by the energy coil 40 serves to operate the microchip 20 and the electronic display 70. Moreover, a logic circuit can be integrated that performs data management and that transfers data from the data coil 41 of the RF component 10 to the display. Texts as well as encrypted information, for example, in the form of barcodes, can be shown on the display in that the bi-stable elements of the electronic ink are oriented accordingly. The information is displayed until a base station activates the display of new information, whereby the energy needed one time for the new information display is obtained via the energy coil 41.

1-12. (canceled)

13. An antenna arrangement for RF systems, comprising:
at least two antenna coils that are installed on a flat, non-conductive carrier, the at least two antenna coils having one or more windings that are applied onto the carrier, the at least two antenna coils being arranged in at least two different layers that are one above the other and that do not touch each other, a first antenna coil of the at least two antenna coils being of a first quality and a second antenna coil of the at least two antenna coils being of a second quality, the first antenna coil being arranged so as to be offset with respect to the second antenna coil in such a way that mutual inductance between the two antenna coils is minimized.

14. The antenna arrangement recited in claim 13, wherein the windings of the first antenna coil and the windings of the second antenna coil overlap in a partial area of each antenna coil.

15. The antenna arrangement recited in claim 13, wherein the distance between the at least two different layers of antenna coils is in the order of magnitude of 0.1 mm to 2 mm.

16. The antenna arrangement recited in claim 13 wherein the at least two antenna coils operate at the same frequency.

17. The antenna arrangement recited in claim 16, wherein the frequency is 13.56 MHz.

18. The antenna arrangement recited in claim 13, wherein the at least two antenna coils are arranged so as to be offset with respect to each other along an axis A that runs through a midpoint of each of the at least two antenna coils.

19. The antenna arrangement recited in claim 18, wherein the at least two antenna coils are configured to be rectangular, each having an outer length L=50 mm and an outer width B=50 mm, the midpoints of each of the antenna coils being arranged so as to be offset with respect to each other by Δ=39 mm along an axis A that runs parallel to four opposite sides of the antenna coils, the first antenna coil having a conductor width of approximately 1 mm, the second antenna coil having a conductor width of approximately 0.75 mm.

20. A device, comprising:
an RF component that includes an antenna arrangement for RF systems, the antenna arrangement comprising at least two antenna coils that are installed on a flat, non-conductive carrier, the at least two antenna coils having one or more windings that are applied onto the carrier, the at least two antenna coils being arranged in at least two different layers that are one above the other and that do not touch each other, a first antenna coil of the at least two antenna coils being of a first quality and a second antenna coil of the at least two antenna coils being of a second quality, the first antenna coil being arranged so as to be offset with respect to the second antenna coil in such a way that mutual inductance between the two antenna coils is minimized.

21. The device recited in claim 20, wherein one of the antenna coils is a narrow-band energy coil that is arranged on the surface of the carrier so as to be offset with respect to a broadband data coil, whereby the mutual inductance between the two antenna coils is minimized, and both antenna coils are connected to an electronic assembly.

22. An electronic device having an RF component for contact-free transmission of energy and data to the electronic device, the RF component including an antenna arrangement for RF systems, the antenna arrangement comprising at least two antenna coils that are installed on a flat, non-conductive carrier, the at least two antenna coils having one or more windings that are applied onto the carrier, the at least two antenna coils being arranged in at least two different layers that are one above the other and that do not touch each other, a first antenna coil of the at least two antenna coils being of a first quality and a second antenna coil of the at least two antenna coils being of a second quality, the first antenna coil being arranged so as to be offset with respect to the second antenna coil in such a way that mutual inductance between the two antenna coils is minimized.

23. The electronic device recited in claim 22, wherein the electronic device is an electronic display based on electronic ink containing bi-stable elements, the electronic display having an RF component for contact-free transmission of energy and data to the electronic display.
